(19) United States
(12) Patent Application Publication
(10) Pub. No.: US 2019/0251515 A1
(43) Pub. Date: Aug. 15, 2019

(54) AN AUTOMATED SYSTEM FOR ONBOARDING AND A METHOD THEREOF

(71) Applicant: Reliance Industries Limited, Mumbai (IN)

(72) Inventors: Harjeet Singh Khanduja, Navi Mumbai (IN); Ashish Kukreja, Panipat (IN); Rahul Mukherjee, Navi Mumbai (IN); Kaushik Chaniyara, Navi Mumbai (IN); Ramamurthy Srinivasan, Thane (IN); Parul Garg, Laxmi Nagar (IN); Hitesh Wankhede, Navi Mumbai (IN); Kuldeep Sharma, Kota (IN); Mayank Garg, Roorkee (IN); Navneet Tewani, Krishna (IN); Neha Sahai, Kalkaji (IN); Riddhi Naik, Navsari (IN); Hardik Dave, Ahmedabad (IN)

(73) Assignee: Reliance Industries Limited, Mumbai (IN)

(21) Appl. No.: 16/318,543

(22) PCT Filed: Jul. 18, 2017
(86) PCT No.: PCT/IB2017/054326

§ 371 Date: Jan. 17, 2019

(30) Foreign Application Priority Data
Jul. 19, 2016 (IN) 201621024720

(51) Int. Cl. G06Q 10/10; G06Q 10/06

(52) U.S. Cl. CPC G06Q 10/1053; G06Q 10/063112

(57) ABSTRACT

The present disclosure envisages an automated system for onboarding. The system comprising a database to store details of existing employees, a vacancy repository to store details related to vacant positions within an organization, a recruitment module to receive candidate application details corresponding to a plurality of candidates, a test module to provide test case to candidates, an assessment module to provide assessment score, a selection module to select candidate based on the assessment score, a pre-boarding module to identify and receive missing details of the selected candidates to obtain complete details, a verifier module to verify the complete details of the selected candidates to obtain verified details, an onboarding module to receive verified details and facilitate onboarding of the selected candidates.

### FIELD

The present disclosure relates to an automated onboarding systems.

### Definitions

The expression ‘candidate’ used hereinafter in this specification refers to, but is not limited to, a person who applies for vacant position in an organization.

The expression ‘Onboarding’ used hereinafter in this specification refers to, but is not limited to, an automated process of posting vacancy details, receiving candidate applications, assessing the candidates, selecting the candidates, creating identities, allocating assets and cubicles to the selected candidates. The expression ‘Ghost Employees Risk’ used hereinafter in this specification refers to, but is not limited to, the risk of having an employee(s) (on the record/payroll of an organization) who has never physically joined the organization but exists only on a paper. Since, the employee usually moves within organization and work location(s) for joining, there is a possibility that an on-boarded employee never reports for work and becomes a ghost employee.

The expression ‘Backdated Joining Risk’ used hereinafter in this specification refers to, but is not limited to, a condition, wherein a candidate(s) reports at a work location and the office location for joining in future. This type of backdated joining exposes the candidate/employee(s) to financial risk due to absence of insurance coverage. At the same time, candidate raises compliance risk for an organization. The combination of employee(s) and employer risk is the backdated joining risk.

The expression ‘Proxy Recruitment Risk’ used hereinafter in this specification refers to, but is not limited to, a risk which can typically arise in mass recruitment, where another person reports for joining instead of the one who has cleared the assessments. There is a need to validate the employee(s) before joining to avoid the proxy recruitment risk.

The expression ‘Asset’ used hereinafter in this specification refers to, but is not limited to, organization asset including company laptops, cellular phones, user credentials to use organization specific applications, domain specific credentials, email access, and the like.

The expression “black list” used hereinafter in this specification refers to, but is not limited to, a list privately exchanged among employers, containing the names of candidates to be barred from employment because of untrustworthiness or for doing unlawful activities.

These definitions are in addition to those expressed in the art.

### BACKGROUND

Typically, in any organization, onboarding of a newly recruited employee takes three to four days. This is due to the lengthy process involved which includes form filling and document submission, verification with original documents and creation of records. The process of submission, verification and creation subsequently leads to asset allocation to the new employee, which marks completion of the onboarding process for the new employee. Particularly, organizations having operations and businesses in various geographies, have to deal with more challenges during the recruitment activities, as such activities tend to happen simultaneously at various locations. Moreover, such organizations face bigger challenges in terms of non-uniformity of recruitment and onboarding experience at the various locations. In order to address this, some organizations create a pre-boarding portal, where candidates can feed details beforehand and upload the necessary documents. However, such portals only allow uploading of documents, which further require verification by authorized personnel. Additionally, employees are still required to travel to office locations for employee code generation and allocation of assets, which consumes time and may spoil a new joiner's experience.

Therefore, there is a need to provide an automated onboarding system and method, which limits the aforementioned drawbacks.

### Objects

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide an automated system for onboarding and a method thereof.

Another object of the present disclosure is to provide an automated system for onboarding which facilitates simplification of the onboarding activities across verticals of an organization.

Yet another object of the present disclosure is to provide an automated system for onboarding which enhances governance in onboarding activities and reduces risk of backdated joining, ghost employees and proxy recruitments.

Still another object of the present disclosure is to provide an automated system for onboarding which operates seamlessly, irrespective of different locations and verticals of an organization.

Other objects and advantages of the present disclosure will be more apparent from the following description, which is not intended to limit the scope of the present disclosure.

### SUMMARY

The present disclosure envisages an automated system for onboarding. The system comprising: a memory, a processor, a database, a vacancy repository, a recruitment module, a pre-boarding module, a verifier module and an onboarding module.

The memory is configured to store a plurality of pre-defined system processing rules. The processor is configured to cooperate with the memory to receive the pre-defined system processing rules and is further configured to generate system processing commands. The database is configured to store details of existing employees. The vacancy repository is configured to store details related to vacant positions within an organization. The recruitment module is configured to receive and store candidate application details with respect to a plurality of candidates, corresponding to the vacant positions. The test module is configured to receive the candidate application details, and is further configured to provide a test case to each of the candidates. The assessment module is configured to receive test responses for the test cases provided to each of the candidates and candidate application details, and is further configured to compute assessment score for each of the candidates. The selection module is configured to receive the assessment score corresponding to each of the candidates and further configured to select the candidates. The pre-boarding module is configured to cooperate with the recruitment module and the selection module to receive the candidate application details of the selected candidates, and further configured to identify and receive missing details from the corresponding selected candidates to obtain complete details of the selected candidates. The verifier module is configured to receive and verify the complete details of the selected candidates to obtain verified details. The onboarding module is configured to receive the verified details, and facilitate onboarding of the selected candidates.

In an embodiment, the verifier module includes a photograph comparator configured to compare a photograph of the selected candidate clicked at a time of the onboarding, with a photograph of the candidate taken at a time of interview to avoid proxy hiring. It also reduces the risk of backdated joining risking large distributed organizations.

In an embodiment, the predefined system processing rules includes assessment rules, selection rules, pre-boarding rules, verification rules, onboarding rules, and allotment rules and the like.

In an embodiment, the onboarding module comprises: an asset repository, a cubicle repository, an employee identification number generator, an allotment module and an updater module.

The asset repository configured to store details relating to occupied and unoccupied assets. The cubicle repository configured to store details relating to occupied and unoccupied cubicles. The employee identification number generator configured to generate a unique employee identification number. The allotment module configured to cooperate with the asset repository, cubicle repository, and the employee identification number generator, and further configured to allot assets, cubicle and the employee identification number to the selected candidates based on the verified details. The updater module configured to update the details relating to allotted assets, cubicle and the employee identification number of selected candidates in the database.

In an embodiment, the pre-boarding module is configured to send an alert to the selected candidates for receiving the missing details.

In an embodiment, the vacant positions details are provided to relevant job portals.

In an embodiment, the details of existing employees include an employee identification number, cubicle information, and allotted assets details.

The present disclosure also envisages a method for automated onboarding comprising the following steps:
storing, in a memory, a plurality of pre-defined system processing rules;
receiving the pre-defined system processing rules and generating system processing commands, by a processor;
storing, in a database, details of existing employees;
storing, in a vacancy repository, details related to vacant positions within an organization;
receiving and storing, by a recruitment module, candidate application details with respect to a plurality of candidates, corresponding to the vacant positions;
receiving the candidate application details, and providing a test case to each of the candidates, by a test module;
receiving test responses for the test cases provided to each of the candidates and the candidate application details, and computing assessment score for each of the candidates, by an assessment module;
receiving the assessment score corresponding to each of the candidates and selecting the candidates based on the assessment score, by a selection module;
receiving the candidate application details of the selected candidates, and identifying and receiving missing details of the selected candidates, from the corresponding selected candidates to obtain complete details, by a pre-boarding module;
verifying the complete details of the selected candidates to obtain verified details, by a verifier module; and
facilitating onboarding of the selected candidates, by an onboarding module.

In an embodiment, the step of facilitating onboarding of the selected candidates comprising the following steps:
storing, in an asset repository, details relating to occupied and unoccupied assets;
storing, in a cubicle repository, details relating to occupied and unoccupied cubicles;
generating, by an employee identification number generator, a unique employee identification number;
allotting, by an allotment module, assets, cubicle and the employee identification number to the selected candidates based on the verified details; and
updating, by an updater module, the details relating to allotted assets, cubicle and the employee identification number of selected candidates in the database.

### BRIEF DESCRIPTION OF THE ACCOMPANYING DRAWING

An automated onboarding system and a method of the present disclosure will now be described with the help of the accompanying drawing, in which:

FIG. 1 illustrates a schematic diagram of an automated system for onboarding, in accordance with an embodiment of the present disclosure.

FIGS. 2A and 2B illustrate a flow diagram showing steps performed by the automated system for onboarding of FIG. 1, in accordance with an embodiment of the present disclosure.

### LIST OF REFERENCE NUMERALS

| Reference Numeral | Reference |
|---|---|
| 100 | automated onboarding system |
| 102 | memory |
| 104 | processor |
| 106 | database |
| 108 | vacancy repository |
| 110 | recruitment module |
| 112 | test module |
| 114 | assessment module |
| 116 | selection module |
| 118 | pre-boarding module |
| 120 | verifier module |
| 122 | onboarding module |
| 124 | asset repository |
| 126 | cubicle repository |
| 128 | employee identification number generator |
| 130 | allotment module |
| 132 | updater module |

### DETAILED DESCRIPTION

In any organization, onboarding of a newly recruited employee takes three to four days, which is a lengthy process including form filling and document submission, verification with original documents and creation of records. The process of submission, verification and creation subsequently leads to asset allocation to the new employee, which marks completion of the onboarding process for the new employee. Particularly, organizations having operations and businesses in various geographies, have to deal with more challenges during the recruitment activities, as, such activities tend to happen simultaneously at various locations. Moreover, such organizations face bigger challenges in terms of non-uniformity of recruitment and onboarding experience at the various locations. In order to address this, some organizations create a pre-boarding portal where candidates can feed details beforehand and upload the necessary documents. However, such portals only allow uploading of documents which further require verification by authorized personnel. Additionally, employees are still required to travel to office locations for employee code generation and allocation of assets, which consumes time and may spoil a new joiner's experience.

Therefore, to limit the aforementioned drawbacks, the present disclosure envisages an automated onboarding system and method which facilitates an on-boarder to use his/her handheld device to complete the onboarding process without wasting time and without any hassle. The system of the present disclosure enables authorized persons to onboard employees at work locations.

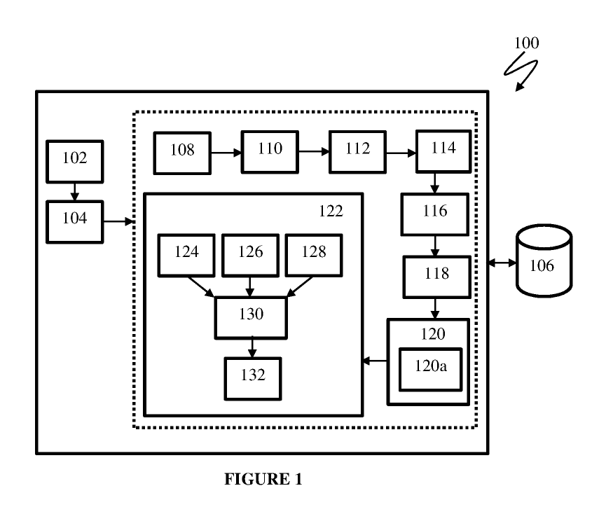

FIG. 1 of the accompanying drawing illustrates a schematic diagram of an automated system (100) for onboarding (hereinafter referred to as ‘system’), in accordance with an embodiment of the present disclosure. The system (100) includes a memory (102), a processor (104), a database (106), a vacancy repository (108), a recruitment module (110), a test module (112), an assessment module (114), a selection module (116), a pre-boarding module (118), a verifier module (120), and an onboarding module (122). The system (100) facilitates an onboarder to use his/her handheld device to complete the onboarding process in automated manner. The handheld device (hereinafter known as ‘user device’) includes, but is not limited to, mobile phones, tablets, desktops, iPads, PDAs, notebooks, net books and the like.

The memory (102) is configured to store a plurality of pre-defined system processing rules and a plurality of test cases. The memory (102) may include any computer-readable medium known in the art including, for example, volatile memory, such as static random access memory (SRAM) and dynamic random access memory (DRAM), and/or a non-volatile memory, such as read only memory (ROM), erasable programmable ROM, flash memories, hard disks, optical disks, and magnetic tapes. In an embodiment, the predefined system processing rules includes assessment rules, selection rules, pre-boarding rules, verification rules, onboarding rules, allotment rules and the like. In an embodiment, the test cases are of different domains.

The processor (104) is configured to cooperate with the memory (102). The processor (104) is configured to process the stored pre-defined system processing rules from the memory (102) to generate system processing commands in order to control the modules of the system (100). The processor (104) may be implemented as one or more microprocessors, microcomputers, microcontrollers, digital signal processors, central processing units, state machines, logic circuitries, and/or any devices that manipulate signals based on operational instructions. Among other capabilities, the processor (104) may be configured to fetch and execute computer-readable instructions that may be stored in the memory (102).

The database (106) is configured to store details of existing employees within an organization. These details of existing employees include employee identification number, cubicle information, and allotted assets details. In one embodiment, the assets include, but are not limited to, organization's laptops, cellular phones, user credentials to use organization specific applications, domain specific credentials, email access and the like.

The vacancy repository (108) is configured to cooperate with the processor (104) to receive system processing commands. The vacancy repository (108) is configured to store details related to vacant positions within the organization for hiring the candidate. These vacancy details are provided to the relevant job portals to receive job applications.

A pseudo code depicting the functionality of the vacancy repository (108), in accordance with an embodiment of the present disclosure, is now described.

1. Let, a XYZ company has vacant positions.

2. A vacancy repository creates a look-up table (i.e. a vacant position look-up table [lookup1]), to enter the details of the vacant positions in the XYZ.

| | |
|---|---|
| 1. | struct vacant_position |
| | { |

char designation;
var position_level;
char role;
int experience;
var department;
int remuneration;

| | |
|---|---|
| | } |
| | *vacancy1; |
| 2. | void create( ) |
| | { |

char designation;
var position_level;
char role;
int experience;
var department;
int remuneration;

| | |
|---|---|
| vacancy1 = (struct vacant_position | *)malloc(sizeof (struct |

vacant_position));

vacancy1→designation = (char *)malloc((size)*(sizeof(char)));
vacancy1→position_level = (var *)malloc((size)*(sizeof(var)));
vacancy1→role = (char *)malloc((size)*(sizeof(char)));
vacancy1→experience = (int *)malloc((size)*(sizeof(int)));
vacancy1→department = (var *)malloc((size)*(sizeof(var)));
vacancy1→remuneration = (int *)malloc((size)*(sizeof(int)));

printf (“Enter designation for vacant position: “/n);
scanf (“ %s”, vacancy1→designation);
printf (“Enter position level: “/n);
scanf (“ %s”, vacancy1→ position_level);
printf (“Enter roles and responsibilities: “/n);
scanf (“ %s”, vacancy1→ role);
printf (“Enter number of experience: “/n);
scanf (“ %s”, vacancy1→ experience);
printf (“Department: “/n);
scanf (“ %s”, vacancy1→ department);
printf (“Enter the range of remuneration: “/n);
scanf (“ %s”, vacancy1→remuneration);

| | |
|---|---|
| 3. | fwrite(&vacancy1→designation, size, 1, fp); |
| | fwrite(&vacancy1→position_level, sizeof(vacancy1→position_level), 1, fp); |
| | fwrite(&vacancy1→role, size, 1, fp); |
| | fwrite(&vacancy1→experience, sizeof(vacancy1→experience), 1, fp); |
| | fwrite(&vacancy1→department, sizeof(vacancy1→department), 1, fp); |
| | fwrite(&vacancy1→ remuneration, sizeof(vacancy1→remuneration), 1, fp); |
| | count++; |
| | fclose(fp); |

}

The recruitment module (110) is configured to cooperate with the processor (104) to receive the system processing commands. The recruitment module (110) is configured to receive and store candidate application details with respect to a plurality of candidates, corresponding to the vacant positions within the organization. In an embodiment, the candidate application details are stored in the database (106). In an embodiment, the candidate application details includes basic information such as job experience, education, certifications, residential address, contact number, email id, skills, photograph, domain, unique identification number (passport number, aadhar number, pan card number) and the like.

A pseudo code depicting the functionality of the recruitment module (110), in accordance with an embodiment of the present disclosure, is now described.
1. Let, a ‘XYZ’ company has vacant positions, and one or more candidates apply for the vacant positions via job portals.
2. A recruitment module stores the candidate details, which receives from the job portals, for reviewing the candidate details by any hiring manager and/or recruiter of the XYZ.
3. The recruitment module creates a look-up table (i.e. candidate details look-up table [lookup2]), to enter the details of the candidates, who have applied for the vacant positions.

| | |
|---|---|
| 4. | struct candidate |
| | { |

char name;
char address;
int contact_number;
var email_id;
char technical_skill;

| | |
|---|---|
| | } |
| | *c_detail; |
| 5. | void create( ) |
| | { |

char name;
char address;
int contact_number;
var email_id;
char technical_skill;

c_detail = (struct candidate *)malloc(sizeof (struct candidate));
c_detail → name = (char *)malloc((size)*(sizeof(char)));
c_detail → address = (var *)malloc((size)*(sizeof(var)));
c_detail → contact_number = (char *)malloc((size)*(sizeof(char)));
c_detail → email_id = (int *)malloc((size)*(sizeof(int)));
c_detail → technical_skill = (var *)malloc((size)*(sizeof(var)));

printf (“Enter name of a candidate: “/n);
scanf (“ %s”, c_detail → name);
printf (“Enter address of the candidate: “/n);
scanf (“ %s”, c_detail → address);
printf (“Enter contact number: “/n);
scanf (“ %s”, c_detail → contact_number);
printf (“Enter email address: “/n);
scanf (“ %s”, c_detail → email_id);
printf (“Enter one or more technical skills: “/n);
scanf (“ %s”, c_detail → technical_skill);

| | |
|---|---|
| 6. | fwrite(&c_detail → name, size, 1, fp); |
| | fwrite(&c_detail →address, size, 1, fp); |
| | fwrite(&c_detail →contact_number, sizeof(c_detail →contact_number), 1, |
| | fp)); |
| | fwrite(&c_detail →email_id, sizeof(c_detail →email_id), 1, fp); |
| | fwrite(&c_detail →technical_skill, sizeof(c_detail →technical_skill), 1, fp); |
| | count++; |
| | fclose(fp); |

}

The test module (112) is configured to cooperate with the processor (104) to receive the system processing commands. The test module (112) is configured to receive the candidate application details and is further configured to provide a test case to each of the candidates. In an embodiment, the test module (112) provides test cases, in accordance the candidate's domain and the details related to vacant positions, for which the candidate has applied. The test cases are online test cases, which can be taken by the candidate in the organization premises or away from the organization premises. The test module (112) generates a link for the test cases and transmits the test cases to the candidates. In an embodiment, the test cases are in the form of, but are not limited to, online case study, online group discussion, objective test, and the like.

The assessment module (114) is configured to cooperate with the processor (104) to receive the system processing commands. The assessment module (114) is configured to receive test responses for the test cases provided to each of the candidates and the candidate application details and is further configured to compute assessment score for each of the candidate. In an embodiment, the assessment module (114) assesses the candidate application details such as job experience, education, certification, skills, and the like. In an embodiment, the assessment score is provided based on the assessment rules, for example giving more assessment score to the candidate who has work experience.

A pseudo code depicting the functionalities of the test module (112) and the assessment module (114), in accordance with an embodiment of the present disclosure, is now described.
1. Select a candidate from lookup2 based on the company's requirements provided in lookup1.
   SELECT NAME N1, ADDRESS A1, CONTACT_NUMBER CN1, EMAIL_ID ID1, TECHNICAL_SKILL TS1;
   FROM CANDIDATE, LOOKUP2
   WHERE EXPERIENCE BETWEEN RANGE1 AND RANGE2
   AND REMUNERATION BETWEEN RANGE1 AND RANGE2
   WHEN MATCHED THEN SELECT_CANDIDATE

2. Provide a test case to the selected candidate. The test case includes aptitude test, language test, interview, and the like.

3. The selected candidate provides the test response.

4. Based on the test response of the selected candidate, an assessment module generates a score, known as an assessment score.

The selection module (116) is configured to cooperate with the processor (104) to receive the system processing commands. The selection module (116) is configured to receive the assessment score corresponding to each of the candidates and further configured to select the candidates based on the assessment score. In an embodiment, the selection module (116) select the candidates based on the assessment score and the selection rules, for example selecting the candidate, who has got highest assessment score.

A pseudo code depicting the functionality of the selection module 116, in accordance with an embodiment of the present disclosure, is now described.
SET ASSESSMENT_SCORE BETWEEN RANGE1 AND RANGE2
WHEN MATCHED THEN SELECT_CANDIDATE

The pre-boarding module (118) is configured to cooperate with the processor (104), the recruitment module (110) and the selection module (116) to receive the system processing commands, and the candidate application details of the selected candidates, respectively. The pre-boarding module (118) is further configured to identify missing details of the selected candidates. In an embodiment, the pre-boarding module (118) sends an alert to the selected candidates for receiving the missing details. Further, the pre-boarding module (118) receives the missing details from the corresponding selected candidates to obtain complete details of the selected candidates.

The verifier module (120) is configured to cooperate with the processor (104) to receive system processing commands. The verifier module (120) is configured to verify the complete details of the selected candidates to obtain verified details. If some discrepancies are found during the verification process, there is an option of blacklisting the selected candidate using the verifier module (120). In an embodiment, the verifier module (120) also identifies and removes the blacklisted candidates. In an embodiment, the verifier module (120) verifies the complete details of the selected candidates using government databases. In an embodiment, the verifier module (120) includes a photograph comparator (120a). The photograph comparator (120a) is configured to compare a photograph of the selected candidate clicked at a time of the onboarding with a photograph of the candidate taken at a time of interview, to avoid proxy hiring.

A pseudo code depicting the functionalities of the pre-boarding module (118) and the verifier module (120), in accordance with an embodiment of the present disclosure, is now described.
1. Check the candidate details stored in the candidate details look-up table.
2. If, any field of the look-up table is missing, then generate an alert to the candidate whose details/fields are missing.

{
while(getch() != NULL)

printf(“\a”);
return 0;
}

3. Candidate provides full details and enters into the NULL field.
4. Verify the provided details entered by the candidate.
5. If, any discrepancy found,
   then the candidate rejected,
      else Continue.

The onboarding module (122) is configured to cooperate with the processor (104) to receive system processing commands. The onboarding module (122) cooperates with the verifier module (120) to receive verified details and facilitates the onboarding of the selected candidates.

The onboarding module (122) comprises an asset repository (124), a cubicle repository (126), an employee identification number generator (128), an allotment module (130) and an updater module (132).

The asset repository (124) is configured to store details relating to occupied and unoccupied assets.

The cubicle repository (126) is configured to store details relating to occupied and unoccupied cubicles.

The employee identification number generator (128) is configured to generate a unique employee identification number. In an embodiment, employee identification number generator (128) includes a random number generator to generate a unique employee identification number.

The allotment module (130) is configured to cooperate with the asset repository (124), the cubicle repository (126), and the employee identification number generator (128), and is further configured to allot assets, cubicle, designation and the employee identification number to the selected candidates based on the verified details. In an embodiment, the allotment module (130) ensures that assets, cubicle and the employee identification number are allocated to the selected candidate immediately on joining the organization. In an embodiment, the allotment module (130) also generates an employment contract based on the designation and the verified details. The employment contract is a standard form contract, having terms and conditions in accordance with the designation of the selected candidate.

The updater module (132) is configured to update the details relating to the allotted assets, cubicle and the employee identification number of the selected candidates in the database (106). In an embodiment, the updater module (132) stores the allotted assets, cubicle and the employee identification number of the selected candidates as new employee data. In an embodiment, the new employee data is conveyed to an authorized person like recruiter and/or hiring manager. In another embodiment, permission of the authorized person is necessary to complete the onboarding process.

In an embodiment, the updater module (132) delists details related to the vacancy position (for which the employee is hired) from the vacancy repository (108) after the onboarding process is completed.

A pseudo code depicting the functionality of the onboarding module (122), in accordance with an embodiment of the present disclosure, is now described.
1. After verification, check and assign the unoccupied cubicles, from the vacant position look-up table (lookup1) to receive the details of the department and designation.
a) There are N numbers of bays in a defined space.
b) A bay N1 contains 1 to X number of cubicles.
c) Identify unoccupied cubicle.
d) Assign the identified cubicle to the selected candidate.
e) Done.
2. Similarly, check and assign the occupied and unoccupied assets, from the vacant position look-up table (lookup1).
   a) There are N numbers of assets in the XYZ.
   b) Identify unoccupied asset.
   c) Assign the identified asset to the selected candidate.
   d) Done.

The system (100) of the present disclosure provides simplified onboarding activities across verticals of the organization e.g. onboarding in supply chain, marketing, IT, Research, sales and the like, and spread across the various location can be linked to a central system. Further, as the photo identification is provided by the selected candidate beforehand, that photo can be verified to avoid ghost employees. The provided photo can also be compared with other photo identification document (like passport) to avoid proxy hiring. In one embodiment, the date when a photo is clicked by the onboarder is considered as a date of joining by the system (100) to avoid backdated joining. The system (100) of the present disclosure provides quick, real time, user friendly, safe and seamless onboarding without any productivity loss. As the onboarding is carried out digitally, a uniform experience is provided to all candidates across all establishments of the organization. Moreover, as the candidate information and documents are verified during pre-joining period, conventionally required paperwork is eliminated and all assets are provisioned for the selected candidate in advance.

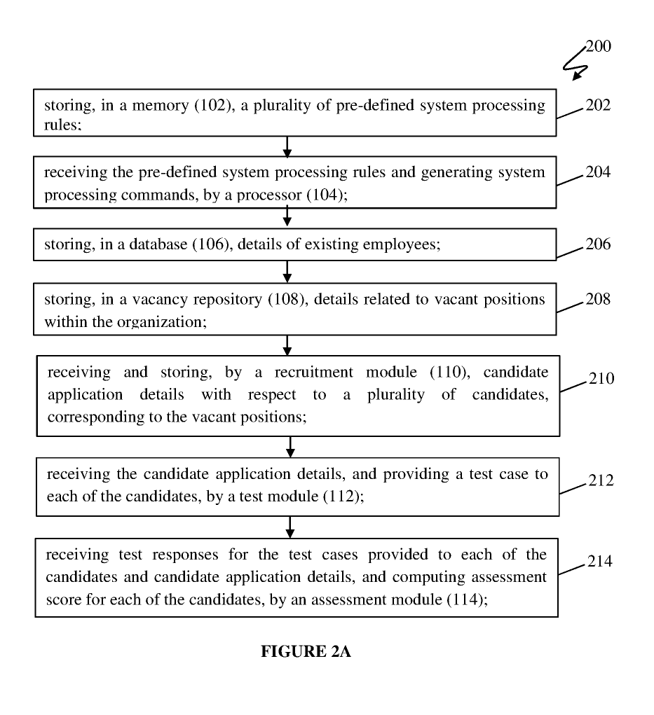

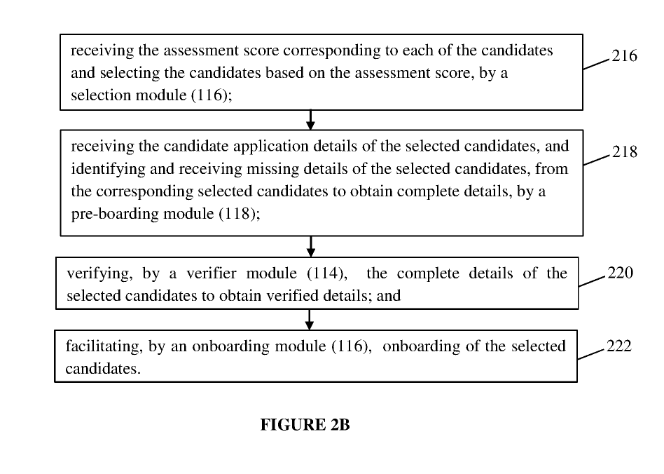

FIGS. 2A and 2B illustrate flow diagram, showing the steps performed by system of FIG. 1.

At block 202, storing a plurality of pre-defined system processing rules. In an embodiment, the memory (102) stores a plurality of pre-defined system processing rules.

At block 204, receiving the pre-defined system processing rules and generating system processing commands. In an embodiment, the processor (104) receives the pre-defined system processing rules and generates system processing commands.

At block 206, storing details of existing employees. In an embodiment, the database (106) stores details of existing employees.

At block 208, storing details related to vacant positions within an organization. In an embodiment, the vacancy repository (108) stores details related to vacant positions within an organization.

At block 210, receiving and storing candidate application details with respect to a plurality of candidates, corresponding to the vacant positions. In an embodiment, the recruitment module (110) receives and stores candidate application details with respect to a plurality of candidates, corresponding to the vacant positions.

At block 212, receiving the candidate application details, and providing a test case to each of the candidates. In an embodiment, the test module (112) receives the candidate application details, and provides a test case to each of the candidates.

At block 214, receiving test responses for the test cases provided to each of the candidates and candidate application details and compute assessment score for each of the candidates. In an embodiment, the assessment module (114) receives test responses for the test cases provided to each of the candidates and candidate application details, and computes an assessment score for each of the candidates.

At block 216, receiving the assessment score corresponding to each of the candidates and selecting the candidates based on the assessment score. In an embodiment, the selection module (116) receives the assessment score corresponding to each of the candidates and selects the candidates based on the assessment score.

At block 218, receiving the candidate application details of the selected candidates, and identifying and receiving missing details of the selected candidates, from the corresponding selected candidates to obtain complete details. In an embodiment, the pre-boarding module (118) receives the candidate application details of the selected candidates, and identifies and receives missing details of the selected candidates, from the corresponding selected candidates to obtain complete details.

At block 220, verifying the complete details of the selected candidates to obtain verified details. In an embodiment, the verifier module (120) verifies the complete details of the selected candidates to obtain verified details.

At block 222, facilitating, onboarding of the selected candidates. In an embodiment, the onboarding module (122) facilitates onboarding of the selected candidates.

### TECHNICAL ADVANCEMENTS

The present disclosure described herein above has several technical advantages including, but not limited to, the realization of an automated onboarding system and method, which:
is user friendly;
facilitates simplification of the onboarding activities across verticals of an organization;
enhances governance in onboarding activities and reduces risk of backdated joining, ghost employees and proxy recruitments; and
operates seamlessly, irrespective of different locations and verticals of an organization.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An automated system (100) for onboarding, said system comprising:
a. a memory (102) configured to store a plurality of pre-defined system processing rules and a plurality of test cases;
b. a processor (104) configured to cooperate with the memory (102) to receive the pre-defined system processing rules and further configured to generate system processing commands;
c. a database (106) configured to store details of existing employees;
d. a vacancy repository (108) configured to store details related to vacant positions within an organization;
e. a recruitment module (110) configured to receive and store candidate application details with respect to a plurality of candidates, corresponding to the vacant positions;
f. a test module (112) configured to receive the candidate application details, and further configured to provide a test case to each of the candidates;
g. an assessment module (114) configured to receive test responses for the test cases provided to each of the candidates and candidate application details, and further configured to compute assessment score for each of the candidates;
h. a selection module (116) configured to receive the assessment score corresponding to each of the candidates and further configured to select the candidates based on the assessment score;
i. a pre-boarding module (118) configured to cooperate with the recruitment module (110) and the selection module (116) to receive the candidate application details of the selected candidates, and further configured to identify and receive missing details of the selected candidates, from the corresponding selected candidates to obtain complete details;
j. a verifier module (120) configured to receive and verify the complete details of the selected candidates to obtain the verified details; and
k. an onboarding module (122) configured to receive the verified details, and facilitate onboarding of the selected candidates.

2. The automated system (100) for onboarding as claimed in claim 1, wherein the verifier module (120) includes a photograph comparator (120a) configured to compare a photograph of the selected candidate clicked at a time of the onboarding, with a photograph of the candidate taken at a time of interview to avoid proxy hiring.

3. The automated system (100) for onboarding as claimed in claim 1, wherein the onboarding module (122) comprises:
a. an asset repository (124) configured to store details relating to occupied and unoccupied assets;
b. a cubicle repository (126) configured to store details relating to occupied and unoccupied cubicles;
c. an employee identification number generator (128) configured to generate a unique employee identification number;
d. an allotment module (130) configured to cooperate with the asset repository (124), the cubicle repository (126), and the employee identification number generator (128), and further configured to allot assets, cubicle and the employee identification number to the selected candidates based on the verified details; and
e. an updater module (132) configured to update the details relating to allotted assets, cubicle and the employee identification number of the selected candidates in the database (106).

4. The automated system (100) for onboarding as claimed in claim 1, wherein the pre-boarding module (118) is configured to send an alert to the selected candidates for receiving the missing details.

5. The automated system (100) for onboarding as claimed in claim 1, wherein the vacant positions details are provided to relevant job portals.

6. The automated system (100) for onboarding as claimed in claim 1, wherein the details of existing employees includes an employee identification number, cubicle information, and allotted assets details.

7. The automated system (100) for onboarding as claimed in claim 1, wherein the predefined system processing rules include assessment rules, selection rules, pre-boarding rules, verification rules, onboarding rules, and allotment rules.

8. A method (200) for automated onboarding comprising the following steps:
a. storing, in a memory (102), a plurality of pre-defined system processing rules;
b. receiving the pre-defined system processing rules and generating system processing commands, by a processor (104);
c. storing, in a database (106), details of existing employees;
d. storing, in a vacancy repository (108), details related to vacant positions within an organization;
e. receiving and storing, by a recruitment module (110), candidate application details with respect to a plurality of candidates, corresponding to the vacant positions;
f. receiving the candidate application details, and providing a test case to each of the candidates, by a test module (112);
g. receiving test responses for the test cases provided to each of the candidates and candidate application details, and computing assessment score for each of the candidates, by an assessment module (114);
h. receiving the assessment score corresponding to each of the candidates and selecting the candidates based on the assessment score, by a selection module (116);
i. receiving the candidate application details of the selected candidates, and identifying and receiving missing details of the selected candidates, from the corresponding selected candidates to obtain complete details, by a pre-boarding module (118);
j. verifying the complete details of the selected candidates to obtain verified details, by a verifier module (120); and
k. facilitating onboarding of the selected candidates, by an onboarding module (122).

9. The method (200) for automated onboarding as claimed in claim 8, wherein the step of facilitating onboarding of the selected candidates comprises the following steps:
a. storing, in an asset repository (124), details relating to occupied and unoccupied assets;
b. storing, in a cubicle repository (126), details relating to occupied and unoccupied cubicles;
c. generating, by an employee identification number generator (128), a unique employee identification number;
d. allotting, by an allotment module (130), assets, cubicle and the employee identification number to the selected candidates based on the verified details; and
e. updating, by an updater module (132), the details relating to allotted assets, cubicle and the employee identification number of the selected candidates in the database (106).
